(19) United States
(12) Patent Application Publication
(10) Pub. No.: US 2007/0027905 A1
(43) Pub. Date: Feb. 1, 2007

(54) Intelligent SQL generation for persistent object retrieval

(75) Inventors: Matthew J. Warren, Redmond, WA (US); Anders Hejlsberg, Seattle, WA (US); Luca Bolognese, Redmond, WA (US); Dinesh Chandrakant Kulkarni, Sammamish, WA (US); Henricus Johannes Maria Meijer, Mercer Island, WA (US); Peter A. Hallam, Seattle, WA (US); Jomo Ahab Fisher, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/193,573

(22) Filed: Jul. 29, 2005

(51) Int. Cl. G06F 17/00

(52) U.S. Cl. 707/103 R

(57) ABSTRACT

A system for converting a query from a representation in a first computing language to an equivalent query in a representation in a second computing language that is different from the first computing language, comprises a query module that accepts a query in an object-oriented representation for translation to an equivalent query in a target query language. The system also includes a translation module that uses the object-oriented representation of the query to create a first version of the query in an idealized version of a target query language and uses the first version of the query to create a second version of the query in an implemented version of the target query language. Methods of using the system are also provided.

### CROSS-REFERENCE TO RELATED APPLICATIONS

This application is related to co-pending U.S. application Ser. No. ------, entitled, “RETRIEVING AND PERSISTING OBJECTS FROM/TO RELATIONAL DATABASES”, filed on Jul. 29, 2005 (Atty. Docket No. MS313938.01/MSFTP1104US), and co-pending U.S. patent application Ser. No. ------, entitled, “CODE GENERATION PATTERNS”, filed on Jul. 29, 2005 (Atty. Docket No. MS313940.01/MSFTP1105US). The entireties of the aforementioned applications are incorporated herein by reference.

### BACKGROUND

More and more frequently, computers are being used to perform various information location and retrieval tasks. Commonly, these information location and retrieval tasks have primarily been in the domain of specialized applications that have been constructed to perform queries against a relational database using a specialized query language. Among the most common of such query languages is the structured query language (SQL). However, recent and dramatic advances in computing technology, for example, increases in processor power and speed and increases in information storage capabilities, have enabled a greater range of information location and retrieval applications on a wider variety of computers.

Traditionally, there have been two main approaches to include information location and retrieval abilities in compiled applications that are written in a high-level programming language. In accordance with the first approach, text of queries written in a query language such as SQL can be encoded as strings within a compiled application program. During execution of the program, text of the query can be passed to a function from an application programming interface (API) that can pass the query to a database to obtain information that results from performance of the query. With the second approach, an embedded text representation of a query is extracted from a source code file by a compiler. The compiler rewrites the query to use an API and re-encodes the query as a text string.

Both of these approaches require an application programmer to know the correct syntax and proper use of a query language in addition to that of the language in which the application programmer is writing his application. Generally, when a query is included in an application using one of these approaches, tasks such as syntax checking are foregone until the application is actually executed, that is, at runtime. Further, there can often be a clash between programming styles for a query language and an application programming language. For example, SQL is a relational data model language that has its own programming style whereas applications are usually written in an imperative programming style using a procedural language such as C or an object-oriented style using either an object-oriented language such as Java, C# or Visual Basic or a mixed procedural--object-oriented language such as C++. It can often be difficult for application programmers to effectively switch between different programming paradigms when creating new applications.

Use of one of these approaches generally also requires an intermediate component, such as an object query language, to perform an object-relational mapping between data represented as an object in an application program and data represented in a format of a relational database. Often these object relational mapping components lack good models for representing how queries are actually performed against the data in the relational database and merely provide a mapping from one data representation form to another. Current systems lack the ability for application programmers to directly incorporate a query as a construct in a high-level programming language that is used to create applications and to translate that query construct into an equivalent query in a query language that can be used by a relational database.

### SUMMARY

The following presents a simplified summary in order to provide a basic understanding of some aspects of the disclosed and described components and methods associated with those components. This summary is not an extensive overview. It is neither intended to identify key or critical elements nor delineate scope. Its sole purpose is to present some concepts in a simplified form as a prelude to the more detailed description that is presented later. Additionally, section headings used herein are provided merely for convenience and should not be taken as limiting in any way.

A query translation system can convert a query that is represented in an object-oriented format, such an object in an application program created in a high-level object-oriented programming language, into an equivalent query in a query language that can be used directly by a database. The system can examine a structure of the object-oriented representation of the query and use that structure to create an equivalent query in an idealized version of a target query language. This equivalent query in the idealized version of the target query language can be converted to an actual query string in an implemented version of the target query language for use in performing a query against a database. The system can take a result set from the database and convert that result set into an object-oriented format that can be used by the application program.

A query translation system can use a multi-stage pipeline to convert a query from a logical representation to a physical representation that can be used directly with a database to perform a query against that database. The multi-stage pipeline can be configured such that different physical representations can be created. The different physical representations can be different query languages, different versions of a single query language, or both.

The disclosed and described components and methods comprise the features hereinafter fully described and particularly pointed out in the claims. The following description and the annexed drawings set forth in detail certain illustrative features. These features indicate a few of the various ways in which the disclosed and described components and methods can be employed. Specific implementations of the disclosed and described components and methods can include some, many, or all of such features and their equivalents. Variations of the specific implementations and examples presented herein will become apparent from the following detailed description when considered in conjunction with the drawings by one of ordinary skill in the art.

### BRIEF DESCRIPTION OF THE DRAWINGS

FIG. 1 is a system block diagram of a query translation system.

FIG. 2 is a schema diagram of an exemplary data relation.

FIG. 3 is a system block diagram of a query translation system.

FIG. 4 is a block diagram of a semantic tree structure.

FIG. 5 is a system block diagram of a multistage pipelined translation system.

FIG. 6 is a schematic diagram of a configurable pipeline.

FIG. 7 is a system block diagram of a query translation system.

FIG. 8 is a flow diagram of a general processing flow that can be used in conjunction with components disclosed or described herein.

FIG. 9 is a flow diagram of a general processing flow that can be used in conjunction with components disclosed or described herein.

FIG. 10 is a flow diagram of a general processing flow that can be used in conjunction with components disclosed or described herein.

FIG. 11 is a system block diagram of an exemplary networking environment.

FIG. 12 is a schematic diagram of an exemplary operating environment.

### DETAILED DESCRIPTION

As used in this application, the terms “component,” “system,” “module,” and the like are intended to refer to a computer-related entity, such as hardware, software (for instance, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

Disclosed components and methods are described with reference to the drawings, wherein like reference numerals are used to refer to like elements throughout. In the following description, for purposes of explanation, numerous specific details are set forth in order to provide a thorough understanding of the disclosed subject matter. It may be evident, however, that certain of these specific details can be omitted or combined with others in a specific implementation. In other instances, certain structures and devices are shown in block diagram form in order to facilitate description. Additionally, although specific examples set forth may use terminology that is consistent with client/server architectures or may even be examples of client/server implementations, skilled artisans will appreciate that the roles of client and server may be reversed, that the disclosed and described components and methods are not limited to client/server architectures and may be readily adapted for use in other architectures, specifically including peer-to-peer (P2P) architectures, without departing from the spirit or scope of the disclosed and described components and methods. Further, it should be noted that although specific examples presented herein include or reference specific components, an implementation of the components and methods disclosed and described herein is not necessarily limited to those specific components and can be employed in other contexts as well.

Artificial intelligence based systems (for example, explicitly and/or implicitly trained classifiers) can be employed in connection with performing inference and/or probabilistic determinations and/or statistical-based determinations as described hereinafter. As used herein, the term “inference” refers generally to the process of reasoning about or inferring states of the system, environment, and/or user from a set of observations as captured by events and/or data. Inference can be employed to identify a specific context or action, or can generate a probability distribution over states, for example. The inference can be probabilistic. For example, an inference can include the computation of a probability distribution over states of interest based on a consideration of data and events.

Inference can also refer to techniques employed for composing higher-level events from a set of events or data. Such inference can result in the construction of new events or actions from a set of observed events and/or stored event data, whether or not the events are correlated in close temporal proximity, and whether the events and data come from one or several event and data sources. Various classification schemes and/or systems (for example, support vector machines, neural networks, expert systems, Bayesian belief networks, fuzzy logic, data fusion engines, or other similar systems) can be employed in connection with performing automatic and/or inferred actions.

Furthermore, the disclosed and described components can be implemented as a method, apparatus, or article of manufacture using standard programming and/or engineering techniques to produce software, firmware, hardware, or any combination thereof to control a computer. The term “article of manufacture” as used herein is intended to encompass a computer program accessible from any computer-readable device, carrier, or media. For example, computer readable media can include but are not limited to magnetic storage devices such as hard disks, floppy disks, magnetic strips, or other types of media; optical disks such as compact disks (CDs), digital versatile disks (DVDs), or other similar media types; smart cards, and flash memory devices such as universal serial bus (USB) thumb drives, secure digital and (SD) cards, among others. Additionally it should be appreciated that a carrier wave or digital signal can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed and described components and methods.

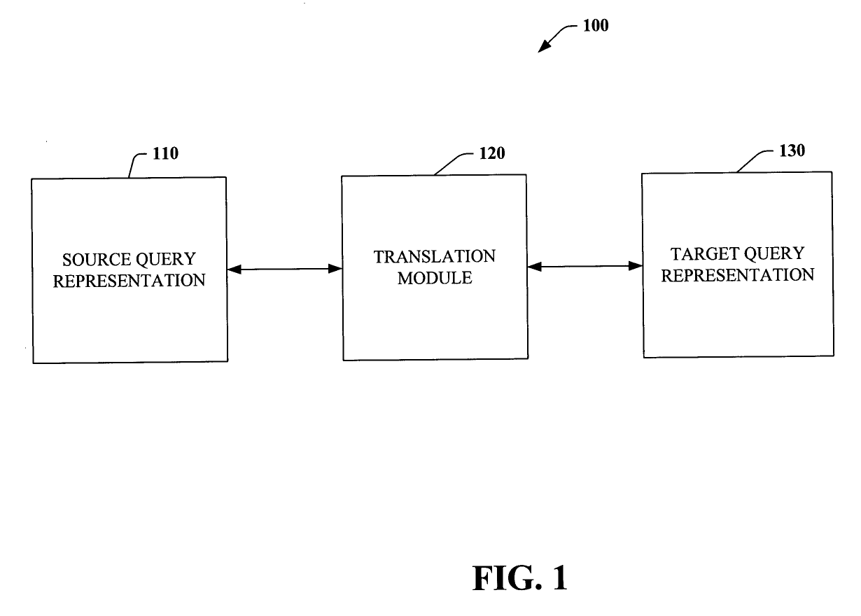

FIG. 1 is a system block diagram of a query translation system 100. The query translation system 100 can be used to translate a query that can be represented in a source language into a semantically equivalent query that can be represented in a target language. Conceptually, the translation can be described as a translation from a logical representation space to a physical representation space. Specifically, the source representation of the query can be a representation that is bound and type checked using rules of a host language, usually a high-level programming language and the target language can be a query language such as SQL that can be used directly by a relational database.

It should be noted that throughout this disclosure, examples are based upon high-level programming languages, SQL, and relational databases. Such references are solely for ease of discussion and to provide examples with which to describe the components and methods presented herein. These specific references and examples are not intended to, and do not imply that the components and methods disclosed and described herein are limited to those examples. To the contrary, the components and methods disclosed and described herein can be used with a wide variety of high-level programming languages, query languages, and types of databases. Specifically, the components and methods disclosed and described herein can find uses and applications in other contexts, particularly in connection with other code generation scenarios including graphics coprocessing and non-relational databases such as extensible markup language (XML) databases, among others. Some modification may be necessary in a specific implementation but such modifications will be readily apparent to one of ordinary skill in the art upon reading this disclosure. Additionally, the terms host language, host programming language, and high-level programming language are used interchangeably.

The query translation system 100 includes a source query representation 110. The source query representation 110 can be any data structure that can semantically represent a query. Examples of such data structures include, but are not limited to, objects, trees, and graphs, among others. Specifically, the source query representation 110 can be a data structure that is bound and type checked in accordance with rules of a host or high-level programming language. Binding and type checking functions can be performed by a compiler that can support the high-level programming language in which the source query representation 110 is created.

The source query representation 110 can directly represent a query in a compiled application program. A data query included in the source query representation 110 can be described in the same syntax as used to program other parts of the application. A supporting compiler can look at the query and perform, in addition to binding and type checking functions, other compile-time tasks such as syntax checking that could otherwise be deferred until runtime. Additionally, the supporting compiler can inject its own overloading rules and coercion rules to ensure program correctness and prevent runtime processing errors.

In an appropriate computing environment, such as an object-oriented environment, the source query representation can be implemented as a semantic tree. The semantic tree can generally represent any application program or portion of an application program that can be expressed in a high-level programming language. For ease of explanation, the examples presented herein limit use of a semantic tree to represent an expression. However, this limitation can be removed where appropriate or desired in a specific implementation. At least in part because the semantic tree is created using the host programming language, the semantic tree is easily consumable by an object-relational implementation at runtime.

Use of a semantic tree can avoid encoding query instructions, for example, SQL statements, into a compiled application program. This approach can allow a compiler to take a pure language expression syntax and encode a data structure that represents all the instructions that otherwise would be included as SQL statements in the form of a tree. A supporting compiler can avoid a need to understand and support a separate language by providing a parser, binding rules, or other things common to properly support a normal programming language.

A translation module 120 can access the source query representation 110 to ascertain details of a query that is encoded in the source query representation 110. Details of such access can vary according to a specific implementation. In the case where the source query representation 110 is implemented as a semantic tree, the semantic tree can be examined by walking through the tree and using a structure of the tree and metadata of the tree to drive a translation from the source query representation 110 to a target query representation 130. The target query representation 130 can be a query that is semantically equivalent to the query encoded in the source query representation 110 but is represented in a target language such as SQL that can be used by a database to actually perform a query against the database and return a set of results.

Metadata of the semantic tree implemented as the source query representation 110 can be obtained from class descriptions for members of the semantic tree. Additionally or alternatively, techniques such as reflection or lightweight reflection can be applied to obtain metadata. Other appropriate techniques can be used as desired or required in a specific implementation.

The translation module 120 can use various techniques to perform a translation from the source query representation 110 to the target query representation 130. For example, the translation module 120 can use various object relational mapping techniques to ascertain which tables, columns, or rows of a relational database are referred to by objects of the source query representation 110. The translation module 120 can also access a library of query structures that are supported by a back-end relational database to construct an SQL query based upon the query encoded in the source query representation 110 that can be performed against the back-end relational database. In this case, use of a separate object query language can be avoided through use of a library that provides query forms that correspond to object structures. Reflection techniques can be used to determine needed information regarding object structures.

Another approach is to use a multi-stage pipelined process to directly translate the source query representation 110 to the target query representation 130 at runtime. Such a multi-stage pipelined process can also avoid use of an object query language during translation. One way of so doing is to employ an idealized version of a target language. This idealized version of the target language can represent all functions and data structures of all versions of a target language. The translation module 120 can first create an idealized version of the query encoded in the source query representation 110 and then convert the idealized version to a version that is actually used by a back-end database. Additionally, the multi-stage pipelined process can fork to provide alternate translations for the same source query representation. Alternate translations can be used to create the target query representation 130 in different versions of a target language, such as SQL-92 or SQL-99, as well as in different target languages such as AQL or DMQL, among others.

In operation, the query translation system 100 can function as follows. The translation module 120 accesses the source query representation 110 to ascertain which resources from a back-end database are needed to perform a query. The translation module 120 also determines how to construct an idealized query that is equivalent to the query that is encoded in the source query representation 110 by examining the structure of the source query representation 110. The idealized query is then translated to the target query representation 130 by identifying any differences between features supported by the idealized language and the actual target language. For each difference, such as an unsupported function, one or more substitute functions are applied to achieve a desired result while still ensuring a correct query. The completed target query 130 is then assembled by the translation module 120 and can be used to perform a query against a database.

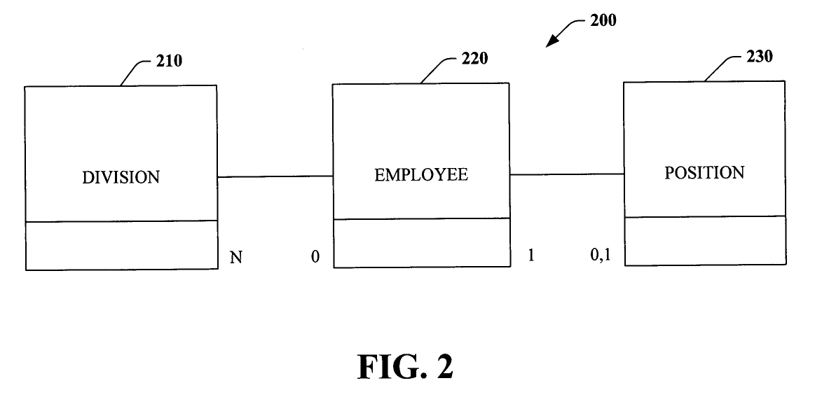

FIG. 2 is a schema diagram of an exemplary data relation 200. The exemplary data relation 200 can be used as the basis for data representations in a variety of languages, including object oriented programming languages for a logical view and SQL for a physical view. Specifically, it can be used as a reference for comparing different data representations.

The exemplary data relation 200 includes a Division 210. The Division 210 can represent a division of a business. An Employee 220 can be related to the Division 210 in a zero-to-many relationship. A Position 230 can be related to the Employee on a Zero- or one-to-one relationship. This schema is the basis for the following example.

The three entities of FIG. 2 described above can be represented in corresponding tables or classes as described below. Classes can be mapped to corresponding tables.

```
create table DivisionTable (
    DivId integer identity,
    DivName  varchar(100),
    CONSTRAINT PK_DivisionTable PRIMARY KEY
(DivId)
)
create table EmployeeTable (
    EmpId integer identity,
    DivId integer not null,
    EmpName  varchar(100),
    StartDate DateTime not null,
    CONSTRAINT PK_EmployeeTable PRIMARY KEY
(EmpId),
    CONSTRAINT FK_EmployeeDivision FOREIGN KEY
(DivId) references DivisionTable(DivId)
)
create table PositionTable (
    PosId integer identity,
    EmpId integer not null,
    PosName  varchar(100),
    Level integer not null,
    CONSTRAINT PK_PositionTable PRIMARY KEY
(PosId),
    CONSTRAINT FK_PositionEmployee FOREIGN KEY
(EmpId) references EmployeeTable(EmpId)
)
```

An outline of the corresponding classes is shown below.

```
class Division
{
    private int id;
    private string name;
    private EntitySet<Employee> employees;
    public int DivId
    {
      get { return id; }
      set { id = value; }
    }
    public string DivName
    {
      get { return name; }
      set { name = value; }
    }
    public EntitySet<Employee> Employees
    {
      // code for managing relationship with
Employee instances
    }
}
class Employee
{
    private int id;
    private string name;
    private EntityRef<Division> division;
    private EntityRef<Position> position;
    public int EmpId
    {
      get { return id; }
      set { id = value; }
    }
    public string EmpName
    {
      get { return name; }
      set { name = value; }
    }
    public EntityRef<Division> Division
    {
      // code for managing relationship with
Division instance
    }
    public EntityRef<Position> Position
    {
      // code for managing relationship with
Position instance
    }
}
class Position
{
    private int id;
    private string name;
    private EntityRef<Employee> employee;
    public int PosId
    {
      get { return id; }
      set { id = value; }
    }
    public string PosName
    {
      get { return name; }
      set { name = value; }
    }
    public EntityRef<Employee> Employee
    {
      // code for managing relationship with
Employee instance
    }
}
```

In the foregoing exemplary code snippets, there are clear correspondences between names of tables in a relational database and names of classes in an object-oriented application program. Fields of the tables can correspond with members of the classes. Also, methods of the classes can correspond to functions provided by the database for performing operations on data. Code to manage relations between or among classes can correspond to table constraints or primary key—foreign key relationships.

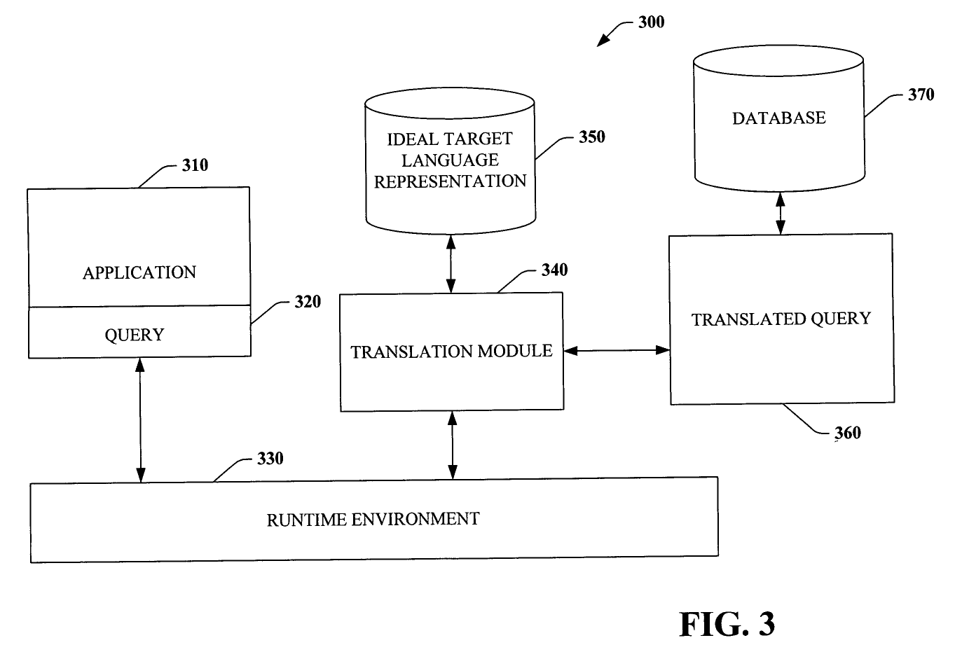

FIG. 3 is a system block diagram of a query translation system 300. The query translation system 300 can be used to translate a query that can be represented in a source language into an equivalent query that can be represented in a target language. Specifically, the source representation of the query can be a representation that is bound and type checked using rules of a host language and the target language can be SQL.

The query translation system 300 includes an application 310 that has an associated query 320. The application can be any application, such as a word processor, a file manager, a service or daemon process, or any other executable application. The query 320 can be part of the compiled code of the application 310 or alternatively can be coupled with that code. In particular, the query 320 can be a semantic tree representation as disclosed and described above in conjunction with FIG. 1.

The application 310 can execute on a runtime environment 330. The runtime environment 330 can be an operating system, an embedded operating system, a virtual machine, or some other appropriate operating environment that can support execution of the application 310. When the application 310 is implemented as an object-oriented application program and the query is implemented as a semantic tree, the runtime environment 330 can support functions for accessing and manipulating objects of the application 310 as needed. These functions can include not only functions for using the semantic tree representation of the query 320 but also at least any functions needed for proper operation of the application 310.

A translator 340 can access the query 320 of the application 310. The translator 340 can also operate on the runtime environment 330. Alternatively, the translator 340 can execute in a different runtime environment so long as some means of accessing the query 320 is provided. The translator can also access an ideal target language representation 350. The ideal target language representation 350 can model an ideal or universal version of a desired target language. For example, SQL-99 includes features that other versions of SQL, such as SQL-92, do not support. Some features of SQL-92 may have been deprecated in SQL-99. An idealized version of SQL modeled in the ideal target language representation 350 can include all features of both SQL-99 and SQL-92. Rules for implementing features of SQL-99 when the ultimate target is SQL-92, such as function equivalencies or programming approaches or algorithms to achieve the result of an unavailable SQL-99 function, can also be included in the ideal target language representation 350. Similarly, rules for implementing deprecated functions from SQL-92 in SQL-99-compliant code can be included.

A translated query 360 can be created by the translator 340. The translated query 360 can be in a real version of a target language, such as SQL-99, instead of an idealized version. This real version of the translated query 360 can be in a form such as a string of text that can be passed directly to a database 370. Passing the translated query 360 to the database 370 can be accomplished in a variety of ways, including through inter-process communication techniques on a computing platform. Additionally or alternatively, the translated query 360 can be passed to a remote database by using a network connection such as a connection to a local area network (LAN), a wide area network (WAN), an intranet, or the Internet, among others. The database 370 can use the translated query 360 to perform a query against the contents of the database 370 and create a result set (not shown).

In operation, the query translation system 300 can function as follows. The application 310 executes on the runtime environment 330. When it is time during execution to process the query 320, the application 310 passes the data structure of the query 320 to the translator 340. The translator 340 walks the data structure of the query 320 and accesses the ideal target language representation 350 to create an idealized representation of the query 320. The translator 340 then accesses the ideal target language representation 350 to determine how to derive the translated query 360 from the idealized version of the query. The translated query 360 is then forwarded to the database 370 for use.

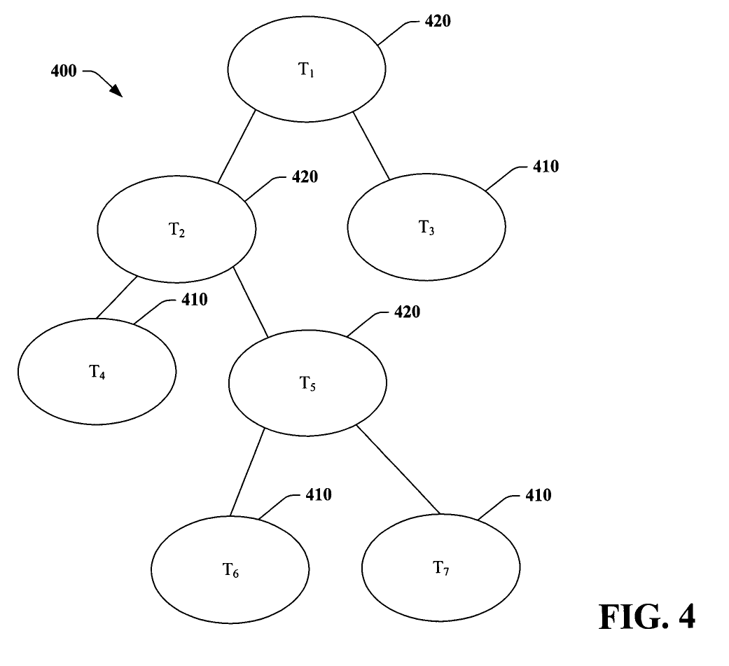

FIG. 4 is a block diagram of a semantic tree structure 400. The semantic tree structure 400 can be used to encode a query in a high-level programming language as a data structure that can be natively handled by a compiler for that programming language. Additionally, the semantic tree structure 400 can be passed to other computing components that can evaluate its structure to obtain the query encoded in the structure.

The semantic tree structure 400 includes a plurality of leaves 410. Each of the leaves 410 can be a scalar reference, a column reference, or some literal that can be used in a representation of a data projection operation. Values included in each leaf 410 can be placed in a projection list that can be used to create a query in a target language.

A plurality of nodes 420 can also be included in the semantic tree 400. Interconnections between or among the nodes 420 can represent nesting, relationships between entities, a hierarchy of projections, or another relational concept that can be modeled. A component such as a translator can walk the semantic tree 400 to discover its structure and ascertain an encoded query. Additionally, nodes 420 and leaves 410 can provide information about themselves through methods such as reflection or lightweight reflection. Other methods of discovering relationships and structures can also be employed.

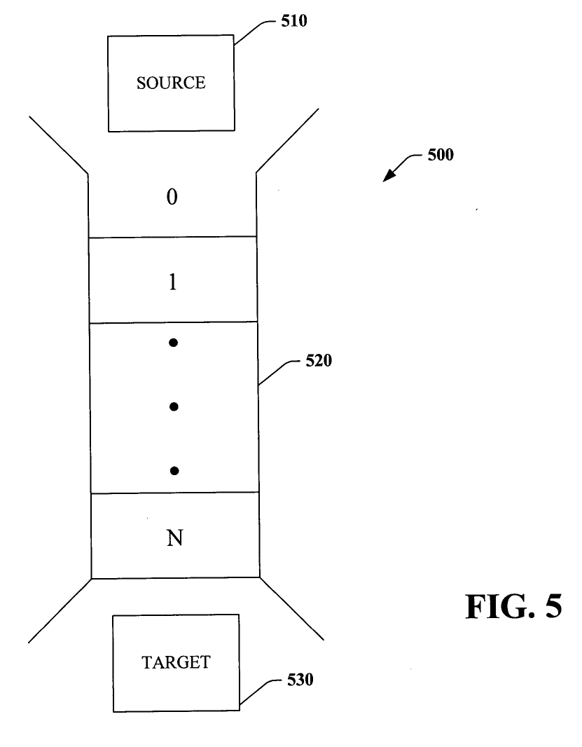

FIG. 5 is a system block diagram of a multistage pipelined translation system 500. The multistage pipelined translation system 500 can be used to convert a query that is logically represented in one space into an equivalent query that is physically represented in another space. For example, the multistage pipelined translation system 500 can take an object-based query, such as a semantic tree or another suitable data structure like a graph, and convert that object-based query into an equivalent SQL statement that can be used immediately by a database.

The multistage pipelined translation system 500 includes a source query 510. The source query 510, as mentioned, can be a semantic tree, a graph, or any other suitable data structure. A multistage pipeline 520 can accept the source query 510 and pass the source query 510 along its stages, performing some work at each stage, until a target query 530 is ultimately created. The target query 530 can be in an appropriate query language, such as SQL, among others.

In this specific example, the multistage pipeline 520 has ten (10) stages. A greater or fewer number of stages can be employed, depending upon needs or desires of a specific implementer. It is possible that the multistage pipeline 520 can be parallelized by performing work of multiple stages substantially simultaneously on multiple processors. Additionally or alternatively, work of a single stage can be parallelized in a similar fashion. Some stages can also be combined into a single stage or a single stage can be broken up into multiple stages. Also, in this example, the original query is in the form of an object, specifically a semantic tree, and the target query is SQL.

In Stage 0, an object query node is translated to an SQL clause. The object query node can be a portion of an overall program that represents the query being mapped. To translate, Stage 0 maps methods of classes to SQL counterparts of those methods. The SQL counterparts are metarepresentations of methods available in the target language. Metarepresentations are constructs in an idealized version of the target language that assist in translation by providing an intermediate representation based upon an idealistic assumption that the target language can represent everything the programming language used to create the object query node can represent. In the case of SQL, the language cannot represent everything that a programming language has the ability to represent at least partly because SQL is not Turing-complete as are most programming languages. In Stage 0, scoping of names is also considered to avoid name collisions.

Stage 1 includes creation of a set of queries such that the single query that was represented by the query object can be translated into multiple SQL queries. This can be done to avoid nesting problems or to simply query translation by creating several simple queries as opposed to a single complex query. Multiple queries can be executed together as a batch if appropriate support is provided for either simulated active result sets or multiple active result sets on the database server being queried. Multiple queries can be simulated by caching results of a query for use by subsequent queries.

In Stage 2, member references are resolved by consulting a mapping table. For example, an object member Division.DivName can be translated into DivisionTable.DivName if so specified by the mapping table. Mappings can also be created for columns and joins between tables in an SQL query. Any translation can be specified in the mapping table. The mapping table can be implemented as a text file, as an object, as a database, or any other suitable implementation.

Separate queries for multisets are created in Stage 3. Associations or properties that can be accessed on an object model, like the Employees data set example of FIG. 2, can yield collections of results. In the idealized version of the target language (SQL) collections can be considered to be a multi-set. A multiset can be a description of a nested table. A single result can yield nested tables of results such as obtaining a hierarchical result from a query. Actual versions of the SQL language cannot support hierarchical results. Processing in Stage 3 looks for these types of results and converts them into multiple queries that can be combined back together at the client end.

Stage 4 reorders OrderBy clauses to satisfy SQL constraints. In actual SQL implementations, the OrderBy clause is only allowed in the outermost query block. OrderBy cannot be used in a subquery or a nested query. In the object representation of the query, ordering can be defined at any level for a particular scope. Reordering is therefore necessary to produce a usable SQL query. Standard query rewriting rules can be employed to ensure correct OrderBy reordering.

In Stage 5, object expressions are translated into flat column references that can be used in SQL queries. Object expressions can be obtained by walking the semantic tree that represents the hierarchy of the subject query. Leaves of that tree can be scalar expressions or column references. These can be placed into a list that represents the projections. The semantic tree that represents the logical result can be pruned by removing pieces that make up the physical result, that is, the SQL query, thus simplifying the remainder of the tree for further analysis.

References to columns and expressions in inner scopes are resolved in Stage 6. In an SQL query, if an outer query uses a column, that column must be in the projection of an inner query. In Stage 6, projections are adjusted to ensure that each reference is visible in the scope within which it is used. For example, when a subquery is created an alias is created. This can start with references to a column that comes from a table alias name. Through transformations layers of queries can be injected. Without rewriting it would not be possible to refer to the alias because it would be buried under multiple layers of subqueries.

The stage processing examines a reference and determines whether that reference is part of a projection that is deeply nested. If so, that column value is projected up through the layers to bring it into the appropriate or desired scope. Processing here does not bind the origin of the column. The processing component only knows that there is a column of some information. This allows the processor to be able to rewrite the semantic tree in any order without regard for an ultimate location of the source of the column. The processor can simply determine where the column is defined and where the column is used to ensure data from the column flows to where it is needed.

Stage 7 assigns names and aliases. Expressions that are defined in an inner query that are used in an outer query are given names. Columns having duplicate names are assigned aliases. Every time there is a subquery or a table that is referred to by a From clause of a Select statement, re-projections of some of the same columns can cause name collisions that result from join operations. Stage 7 searches for these name collision occurrences and assigns new names as needed or appropriate. Additionally, unnamed items are assigned names.

Query parameters are created from literals and expressions with program variables in Stage 8. The Stage 8 processor examines the query for any reference to something that is actually an external parameter. These external parameters are collected and evaluated with semantic tree fragments to obtain the actual values and submit those values through the appropriate API when the actual query made. Parts of the tree that are not things that can be translated into a SQL command but can be translated into parameter references in a SQL command are snipped off. This approach minimizes problem of SQL injection and thereby increases data security. In at least some part, this is because there are no strings to concatenate. If a programmer desires to represent a literal value or local value he can simply use that value in the query. That value can be captured in an expression tree, and subsequently used.

Stage 9 simply assembles all query pieces of the translated query and sets those pieces as a text string that can be passed to a database as a query. The text string can be target query 530 that emerges from the multistage pipeline 520 upon completion of processing. The text string can be a complete SQL statement that can be used to create a result set that can be used in further processing by an application program.

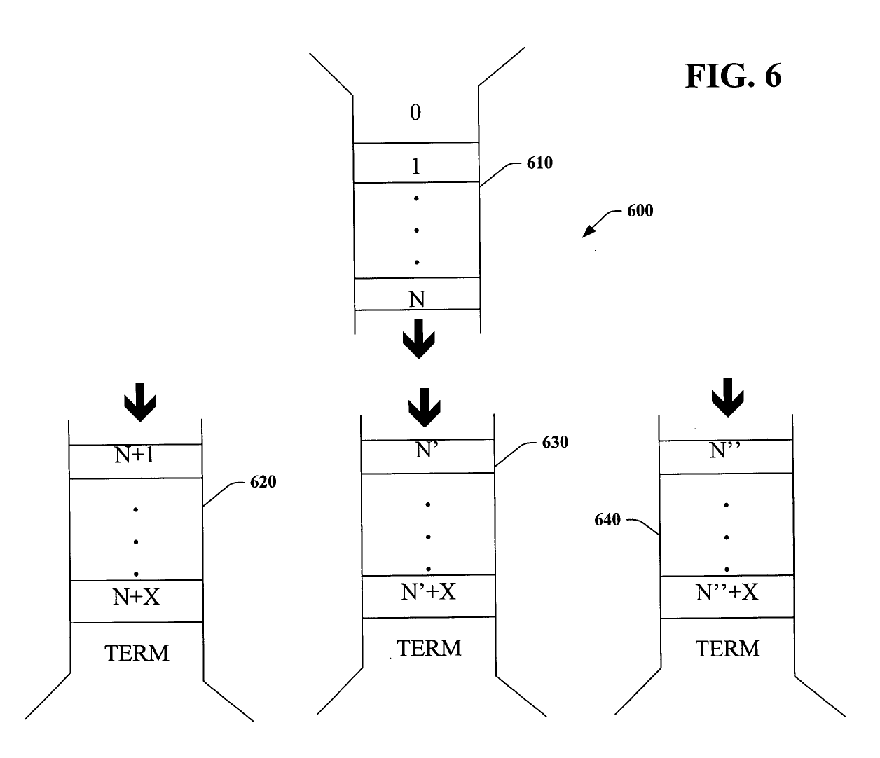

FIG. 6 is a schematic diagram of a configurable pipeline 600. The configurable pipeline 600 can be used to create translated queries in different target languages. Specifically, the translated queries can be targeted for different versions of a query language such as SQL-92 and SQL-99, or can be targeted for different languages altogether.

The configurable pipeline 600 includes an input phase 610. The input phase 610 can include one or more processing stages, such as the processing stages disclosed and described above in conjunction with FIG. 5. In particular, the input phase 610 can include those processing stages that are to be performed regardless of a target language chosen. Exactly which stages are included is largely dependent upon the amount of configurability of the pipeline that is desired and similarity of target languages, among other factors.

Output phases 620, 630, 640 can be used to complete a processing pipeline that begins with the input phase 610. Each output phase 620, 630, 640 can be designed to target a specific language or language version. Selection of an output phase 620, 630, 640 can therefore be made simply by knowing which language or language version is to be targeted for translation. Exactly which stages are included in each output phase 620, 630, 640 is largely dependent upon which stages are included in the input phase 610, among other factors.

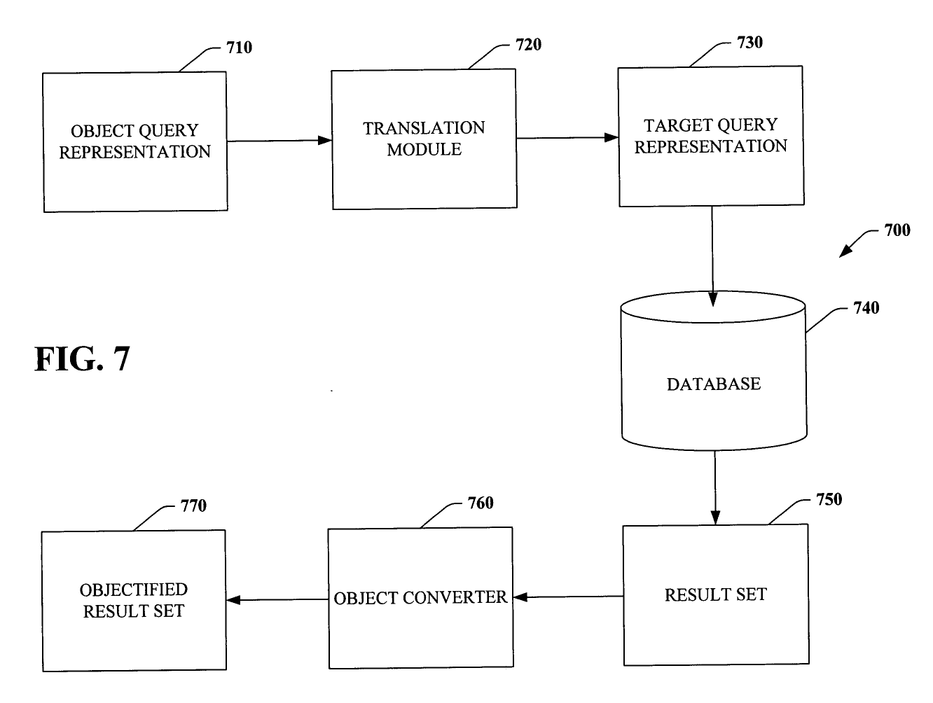

FIG. 7 is a system block diagram of a query translation system 700. The query translation system 700 can be used to convert a query from a logical expression to a physical expression. Additionally, the query translation system 700 can be used to translate a query result set to an object representation that can be used by an application program that included the original query.

The query translation system 700 includes an object query representation 710. The object query representation 710 can be a semantic tree, a graph, or some other suitable representation. A translation module 720 can accept the object query representation 710 and convert the object query representation 710 to an equivalent query in a target language, such as a target query representation 730. In addition to the mapping techniques previously disclosed and described in conjunction with other figures, the translation module 720 can use various artificial intelligence-based components to determine whether a mapping between an object and an SQL statement should be made.

The translation module 720 can use a variety of methods to match at least a portion of an object such as a semantic tree with appropriate code in an idealized version of a target language. In addition to a number of conventional matching procedures, the translation module 720 can use a neural network, an expert system, a rules-based processing component, or a support vector machine (SVM).

A classifier is a function that maps an input attribute vector, X=(x1, x2, x3, x4, . . . xn), to a confidence that the input belongs to a class, that is, f(X)=confidence(class). Such a classification can employ a probabilistic and/or statistical-based analysis (for example, factoring into the analysis utilities and costs) to prognose or infer an action that a user desires to be automatically performed. In the case of the translation module 720, the semantic tree can be treated as a pattern that can be classified to determine whether such patterns match a corresponding pattern of SQL statements. Other pattern-matching tasks can also be employed as will be evident to an artisan of ordinary skill upon reading this disclosure.

An SVM is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naive Bayes, Bayesian networks, decision trees, and probabilistic classification models providing different patterns of independence can be employed. Classification as used herein also includes statistical regression that is utilized to develop models of priority.

As will be readily appreciated from the subject specification, components disclosed or described herein can employ classifiers that are explicitly trained (for example, by a generic training data) as well as implicitly trained (for example, by observing user behavior, receiving extrinsic information). For example, SVMs can be configured by a learning or training phase within a classifier constructor and feature selection module. Thus, the classifier(s) can be used to automatically perform a number of functions including but not limited to determining whether a descriptor matches a search object.

A database 740 can accept the target query representation 730 and perform a query against included data to create a result set 750. In this example, the database 740 can be a relational database and the result set 750 can be a table that includes a plurality of rows and a plurality of columns. Other types of databases can also be used with appropriate modifications to other components of the query translation system 700.

An object converter 760 can accept the result set 750 and use that result set 750 to create an objectified result set 770. To do so, the object converter 760 can access the SQL query sent to the database 740 and use the internal representation of the SQL query to construct specialized objects to read objects, singletons, columns, and deferred readers. For example, a query for Division objects can results in the creation of a DataReader with rows from DivisionTable. An object reader can convert each row into a Division object. The Including() operator can result in immediate loading of a Division.Employees collection.

A collection reader can convert rows from an EmployeeTable of a division into a Division.Employees collection. A query for Employee.Position can result in a singleton reader for Position. A query for Employee.EmpId can require a column reader for the EmpId value. Deferred (or delayed) loading of Division.Employees can be handled by a deferred reader. Each specialized reader can understand the metadata for the underlying DataReader (columns and their types) as well as the metadata for the target (CLR type, its members, cardinality).

In operation, the query translation system can function as follows. The translation module 720 can accept the object query representation 710 and process that object query representation 710 to create the target query representation 730. The database 740 can accept the target query representation 730 and perform a query using the target query representation 730 to create the result set 750. The object converter use the target query representation 730 to create a set of specialized readers that can process the information in the format of the result set 750 to create the objectified result set 770.

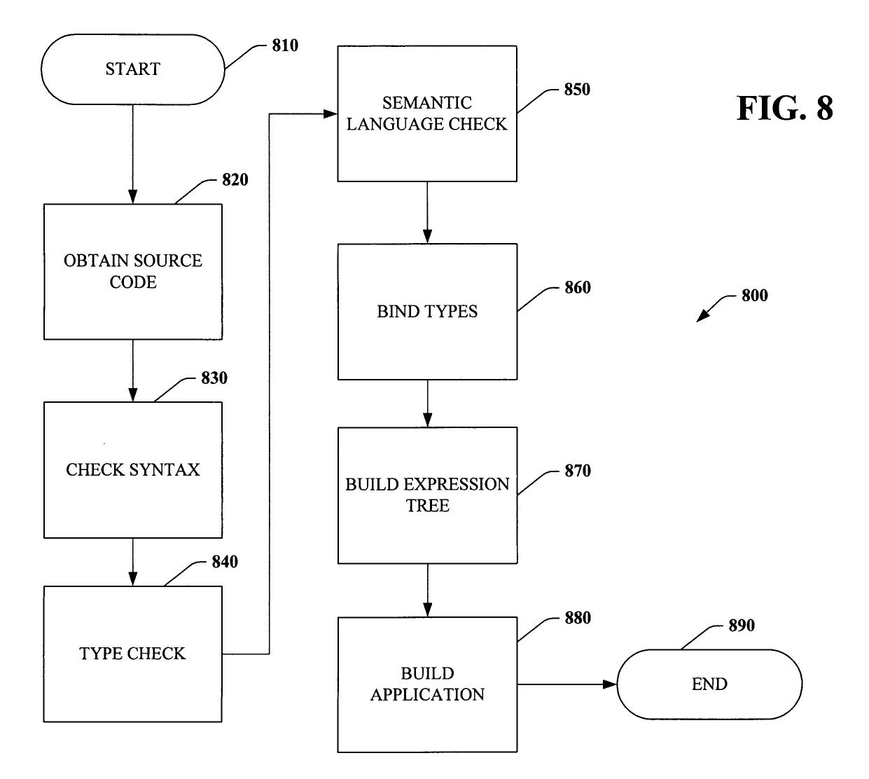

FIG. 8 is a flow diagram of a general processing flow of a method 800 that can be employed in conjunction with components that have been disclosed or described with reference to other figures. The method 800 can be used to incorporate queries into application programs. In particular, the method 800 can be used to incorporate a query into an application program using the programming language in which the application program was written such that the query can be type checked, syntax checked, and bound by a compiler at compile time.

Processing of the method 800 begins at START block 810 and proceeds to process block 820. At process block 820, source code for an application program that is written in some high-level programming language is obtained. The source code can include at least one query that is constructed in that high-level programming language. Processing continues to process block 830 where a compiler for that high-level programming language performs a syntax check on the source code, including any queries.

Processing of the method 800 continues to process block 840 where the compiler performs a type check for all types in the source code. At process block 850, the compiler performs a semantic check upon the language of the source code to ensure compliance with any semantic rules. Processing continues to process block 860 where the compiler binds types in the source code. At process block 870, an expression tree that represents the query is built by the compiler. A complete application program including the expression tree is built at process block 880. Processing concludes at END block 890.

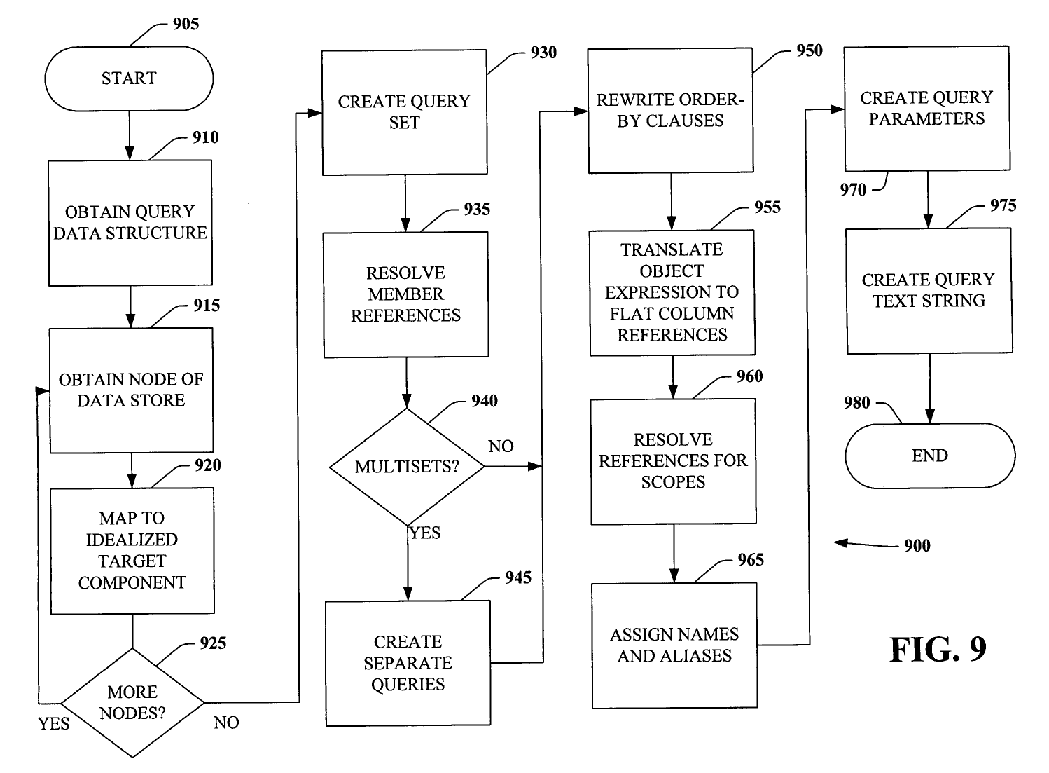

FIG. 9 is a flow diagram of a general processing flow of a method 900 that can be employed in conjunction with components that have been disclosed or described with reference to other figures. The method 900 can be used to translate queries of application programs. In particular, the method 900 can be used to translate a query that can be included an application program as an object of the programming language in which the application program was written into an equivalent SQL query at runtime.

Processing of the method 900 begins at START block 905 and continues to process block 910. At process block 910, a query data structure, such as an expression tree, is obtained from an application program. A node of the data structure that encodes the query is obtained at process block 915. Processing continues to process block 920 where the node of the data structure is mapped to an idealized target language component.

At decision block 925, a determination is made whether the data structure has more nodes to be mapped. If yes, processing returns to process block 915 where another node is obtained. If no, processing continues to process block 930 where a query set is created. At process block 935, member references are resolved. Processing continues to decision block 940 where a determination is made whether multisets are being employed.

If the determination made at decision block 940 is yes, processing continues to process block 945 where separate queries are created. Processing from either a negative determination at decision block 940 or from process block 945 continues to process block 950 where any OrderBy clauses included in the query are rewritten to comply with restrictions of a target query language. At process block 955, object expressions are translated to flat column references. Processing continues to process block 960 where references for all scopes are resolved.

At process block 965, names and aliases are assigned to eliminate name collisions. Processing continues to process block 970 where query parameters are identified and created. A query text string is created at process block 975. Processing of the method 900 concludes at END block 980.

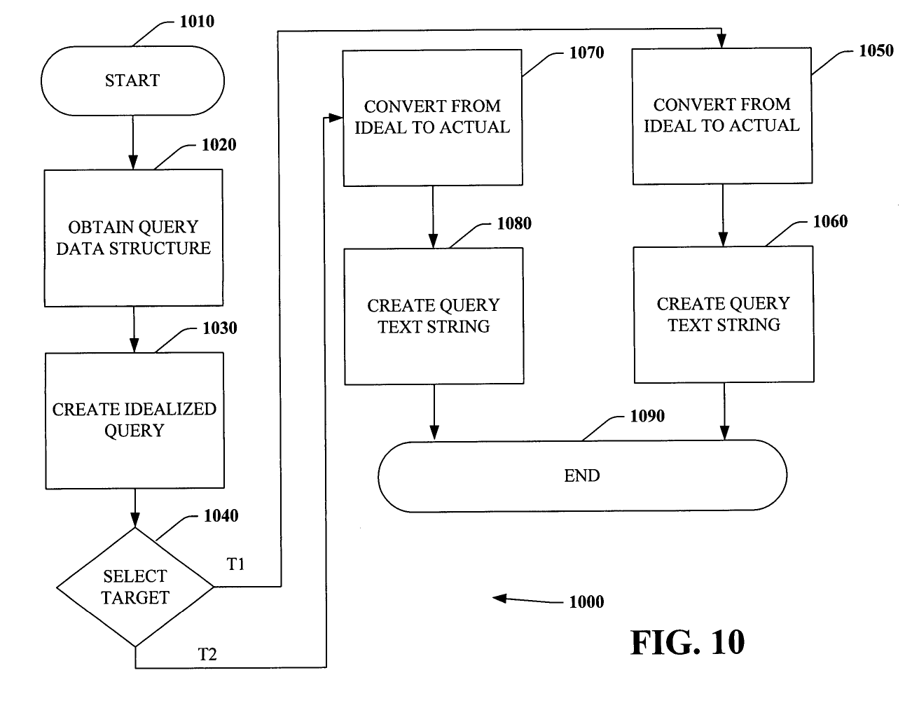

FIG. 10 is a flow diagram of a general processing flow of a method 1000 that can be employed in conjunction with components that have been disclosed or described with reference to other figures. The method 1000 can be used to translate queries from application programs. In particular, the method 1000 can be used to translate a query that was compiled into an application program by using the programming language in which the application program was written into an equivalent query in a target language that can be selected.

Processing of the method 1000 begins at START block 1010 and continues to process block 1020. At process block 1020, a query data structure, such as an expression tree, a graph, or any other suitable data structure, is obtained from an application program. An idealized target query is created at process block 1030. At decision block 1040, a determination is made regarding which of two or more available language versions is to be the target for the translated query.

If the determination made at decision block 1040 is that language T1 is to be targeted, processing continues to process block 1050. At process block 1050, a conversion from an idealized representation of the target language to an actual language version representation is performed. Processing continues to process block 1060 where the converted query is set as a text string that can be passed to a database to perform a query based upon query statements included in the text string.

If the determination made at decision block 1040 is that language T2 is to be targeted, processing continues to process block 1070. At process block 1070, a conversion from an idealized representation of the target language to an actual language version representation is performed. Processing continues to process block 1080 where the converted query is set as a text string that can be passed to a database to perform a query based upon query statements included in the text string. Processing from either process block 1060 or process block 1080 terminates at END block 1090.

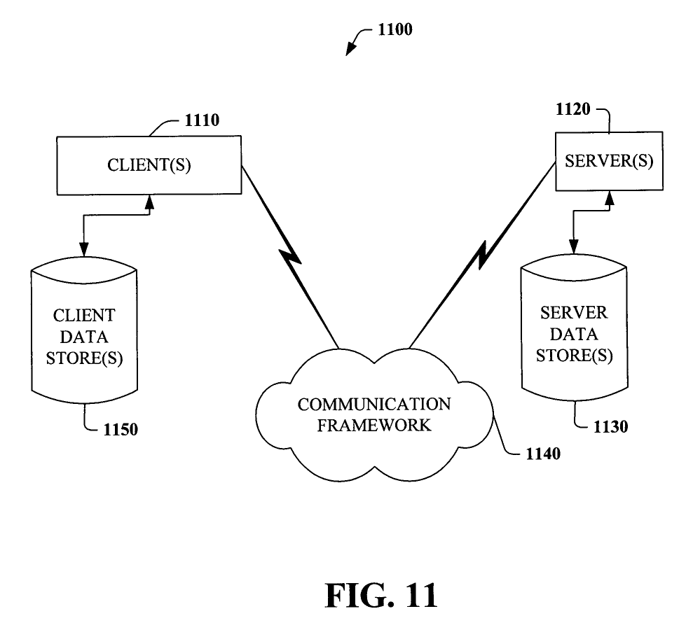

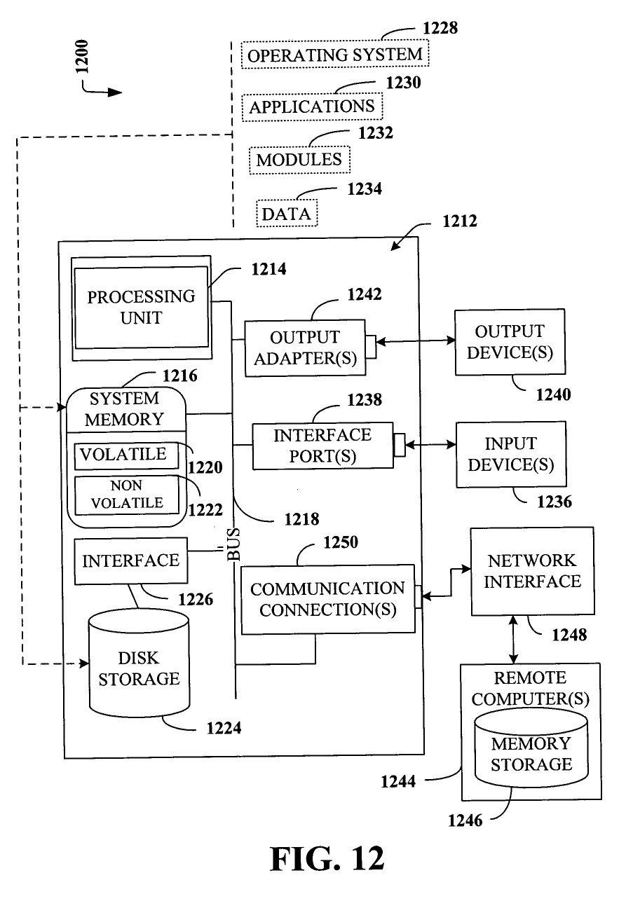

In order to provide additional context for implementing various aspects of the subject invention, FIGS. 11-12 and the following discussion is intended to provide a brief, general description of a suitable computing environment within which various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 11 is a schematic block diagram of a sample-computing environment 1100 with which the subject invention can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads or processes to perform transformations by employing the subject invention, for example.

One possible means of communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1140.

With reference to FIG. 12, an exemplary environment 1200 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. For example, FIG. 12 illustrates a disk storage 1224. The disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. The operating system 1228, which can be stored on the disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. The input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes illustrative examples of certain components and methods. It is, of course, not possible to describe every conceivable combination of components or methodologies, but one of ordinary skill in the art will recognize that many further combinations and permutations are possible. Accordingly, all such alterations, modifications, and variations are intended to fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (for example, a functional equivalent), even though not structurally equivalent to the disclosed structure, which performs the function in the herein illustrated examples. In this regard, it will also be recognized that the disclosed and described components and methods can include a system as well as a computer-readable medium having computer-executable instructions for performing the acts and/or events of the various disclosed and described methods.

In addition, while a particular feature may have been disclosed with respect to only one of several implementations, such feature can be combined with one or more other features of the other implementations as desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for converting a query from a representation in a first computing language to an equivalent query in a representation in a second computing language that is different from the first computing language, comprising:
a query module that accepts a query in an object-oriented representation for translation to an equivalent query in a target query language; and
a translation module that uses the object-oriented representation of the query to create a first version of the query in an idealized version of a target query language and uses the first version of the query to create a second version of the query in an implemented version of the target query language.

2. The system of claim 1, wherein the object-oriented representation of the query is a graph.

3. The system of claim 1, wherein the object-oriented representation of the query is an expression tree.

4. The system of claim 3, wherein the target query language is the structured query language (SQL).

5. The system of claim 4, wherein the translation module includes a multi-stage pipeline.

6. The system of claim 5, wherein the multi-stage pipeline is configurable.

7. The system of claim 6, wherein configuration of the multi-stage pipeline determines which of a plurality of query languages is used as the target language.

8. The system of claim 7, further comprising an object translator that creates an object-oriented representation of a hierarchical result set, wherein the hierarchical result set includes information that is assembled from more than one query against a database.

9. A method for translating a query from an object-oriented representation to a data query language representation, comprising:
using a query represented in an object-oriented format to create an equivalent query in an idealized format of a data query language; and
using the equivalent query in the idealized format to create a second equivalent query in a format of an actual version of the data query language.

10. The method of claim 9, further comprising using a multi-stage pipeline to create the second equivalent query.

11. The method of claim 10, wherein using a query represented in an object-oriented format includes using a semantic tree.

12. The method of claim 10, wherein using a multi-stage pipeline includes configuring the multistage pipeline to target a specific query language.

13. The method of claim 12, further comprising using the second equivalent query to obtain a result set from a database.

14. The method of claim 13, further comprising converting the result set to an object-oriented format.

15. A system for translating a query from an object-oriented representation to a data query language representation, comprising:
means for using a query represented in an object-oriented format to create an equivalent query in an idealized format of a data query language; and
means for using the equivalent query in the idealized format to create a second equivalent query in a format of an actual version of the data query language.

16. The system of claim 15, further comprising means for using a multi-stage pipeline to create the second equivalent query.

17. The system of claim 16, wherein the means for using a query represented in an object-oriented format includes means for using a semantic tree.

18. The system of claim 17, wherein the means for using a multi-stage pipeline includes means for configuring the multistage pipeline to target a specific query language.

19. The system of claim 18, further comprising means for using the second equivalent query to obtain a result set from a database.

20. The system of claim 19, further comprising means for converting the result set to an object-oriented format.
